(19) United States
(12) Patent Application Publication
(10) Pub. No.: US 2025/0313735 A1
(43) Pub. Date: Oct. 9, 2025

(54) Dually Curable Adhesive Composition

(71) Applicant: Henkel AG & Co. KGaA, Düsseldorf (DE)

(72) Inventors: MinRui Li, Shanghai (CN); XiaoKe Zhang, Shanghai (CN); Yongxia Wang, Bridgewater, NJ (US); Zhanzheng Qi, Shanghai (CN); Qing Du, Shanghai (CN)

(21) Appl. No.: 19/243,132

(22) Filed: Jun. 19, 2025

Related U.S. Application Data
(63) Continuation of application No. PCT/CN2022/141155, filed on Dec. 22, 2022.

(51) Int. Cl. C09J 175/14; C08G 18/12; C08G 18/67

(52) U.S. Cl. CPC C09J 175/14; C08G 18/12; C08G 18/675

(57) ABSTRACT

The present invention provides a dually curable adhesive composition comprising (A) at least one isocyanate-terminated polyurethane prepolymer, (B) at least one radical polymerizable compound, (C) at least one photoinitiator, and (D) at least one moisture curing catalyst, wherein the composition after UV radiation with a wavelength of 375 nm and intensity of 50 mW/cm² for 60 seconds, has a loss factor value larger than 0.6, as measured at room temperature in accordance with ASTM D4440-15.

### TECHNICAL FIELD

The present invention relates to a dually curable adhesive composition and use thereof. In particular, the present invention relates to a dually curable adhesive composition exhibiting remarkable compressibility after exposure to UV irradiation and use thereof.

### BACKGROUND OF THE INVENTION

Ultraviolet (UV) curable adhesives have been widely used for structural bonding in consumer electronics devices owing to its fast-curing speed and high bonding strength, however the UV transparent substrates are usually required.

For bonding non-UV transparent substrates, alternative adhesive technologies such as moisture-curable polyurethane adhesives, two-parts structural adhesives, heat-curable epoxy adhesives are adopted. However, these technologies have various shortcomings. For example, moisture curable adhesives are unable to reach fast curing speed to meet the demand for higher production assembly efficiency in electronics industry; two-parts structural adhesives bring more complexity during the assembly process; heat-curable epoxy adhesives are not suitable for bonding heat sensitive substrates because high temperature leads to deformation of the substrate material.

As a sound approach to achieve fast curing speed for bonding non-UV transparent substrates, a dually curable adhesive containing both UV curable composition and moisture curable composition have been disclosed in the prior arts. These dually curable adhesives generally comprise polyurethane prepolymer as moisture curable compound, (meth)acrylates as radical polymerizable compound and photoinitiator. To activate the UV curable adhesive part, the assembly sequence shall be exposing UV prior to laminating the non-UV transparent substrates to the adhesive composition. By doing such way, it may be difficult for lamination if the “semi-cured” (UV part is cured while moisture curable part is not started to cure) adhesive's compressibility is not sufficient, that is to say, the “semi-cured” adhesive is not easy to compress after irradiation thus limiting the workability. None of the prior art suggest how to solve this technical problem.

In view of the above, there is still a need for developing a dually curable adhesive composition exhibiting remarkable compressibility after exposure to UV irradiation without diminishing its fast-curing speed and bonding strength when cured concurrently.

### SUMMARY OF THE INVENTION

According to a first aspect of the invention, disclosed herein is a dually curable adhesive composition comprising,
(A) at least one isocyanate-terminated polyurethane prepolymer,
(B) at least one radical polymerizable compound,
(C) at least one photoinitiator, and
(D) at least one moisture curing catalyst,
wherein the composition after UV radiation with a wavelength of 375 nm and intensity of 50 mW/cm² for 60 seconds, has a loss factor value larger than 0.6, as measured at room temperature in accordance with ASTM D4440-15.

According to a second aspect of the invention, provided herein is a laminate, comprising a first substrate, a second substrate, and an adhesive layer sandwiched therebetween, wherein the first and second substrates are independently of each other selected from a glass, a resin and a metal, preferably at least one of the two substrates is non-UV transparent, and the adhesive layer being formed by curing the adhesive composition of the present invention.

According to a third aspect of the invention, provided herein is an electronic device, comprising the laminate of the present invention or produced using the adhesive composition according to the present invention.

According to a fourth aspect of the invention, provided herein is the use of the adhesive composition according to the present invention or the laminate according to the present invention in manufacturing electronic devices.

Other features and aspects of the subject matter are set forth in greater detail below.

### BRIEF DESCRIPTION OF THE FIGURES

FIG. 1 shows rheological curves of Example 1 and Comparative Example 1 measured by using Modular Compact Rheometer MCR 302e from Anton Paar.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “UV radiation” used herein means ultraviolet radiation at the wavelength of from 200 to 410 nm.

The term “amorphous” used herein means having no melt transition when measured using Differential Scanning calorimetry (DSC).

The term “crystalline” used herein means having a melt transition when measured using Differential Scanning calorimetry (DSC).

The term “room temperature” as used herein refers to a temperature of about 20° C. to about 25° C., preferably about 25° C.

The term “oligomer” as used herein refers to low molecular polymers comprising from 10 to less than 100 repeat units of the same or different types.

The term “polymer” means a macromolecular compound composed of repeated units of the same or different types. The term “polymer” includes homopolymers and copolymers. The term “copolymer” should be understood as a polymer derived from two or more monomers, that is to say, the term “copolymer” includes bipolymers, terpolymers, tetrapolymers and so on. Also, the terms “monomer” according to the disclosure is distinguished from a polymer and means a compound having a weight average molecular weight (Mw) of 2,000 or less.

Unless specified otherwise, the recitation of numerical end points includes all numbers and fractions subsumed within the respective ranges, as well as the recited end points.

The molecular weights refer to number average molecular weights (Mn), unless otherwise stipulated. All molecular weight data refer to values obtained by gel permeation chromatography (GPC), unless otherwise stipulated, e.g., according to DIN 55672.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

In one aspect, the present disclosure is generally directed to a dually curable adhesive composition comprising,
(A) at least one isocyanate-terminated polyurethane prepolymer,
(B) at least one radical polymerizable compound,
(C) at least one photoinitiator, and
(D) at least one moisture curing catalyst,
   wherein the composition after UV radiation with a wavelength of 375 nm and intensity of 50 mW/cm² for 60 seconds, has a loss factor value larger than 0.6, as measured at room temperature in accordance with ASTM D4440-15.

### Loss Factor Value

According to the present invention, the dually curable adhesive composition after UV radiation with a wavelength of 375 nm and intensity of 50 mW/cm² for 60 seconds, has a loss factor value larger than 0.6, as measured at room temperature in accordance with ASTM D4440-15.

Within the above range, the adhesive composition after radiation can be easily compressed, and the mechanical property can be further enhanced during the moisture curing over the next couple of hours, thus a wide time range for workability can be guaranteed.

In the present invention, the loss factor (that is, the damping value) tan ö is obtained by a rheological curve measured by a rheometer equipped with a UV light source in accordance with dynamic oscillation test of ASTM D4440-15, wherein the rheometer can be Modular Compact Rheometer MCR 302e or other types of rheometers from Anton Paar, and the UV light source can be LUMEN DYNAMICS OmniCure SERIES 1000. The measurement is operated under a frequency of 10 rads per second.

An explementary measurement according to ASTM D4440-15 is stated as follows: firstly, a plate clamp having a diameter of 25 mm and a thickness of 1 mm is used to hold the dually curable adhesive composition sample, and when the a frequency of 10 rads at room temperature and the strain is less than or equal to 0.01%, rheological measurement under oscillation mode is performed for some time for stabilization, and then starting UV radiation with a wavelength of 375nm and intensity of 50 mW/cm² for 60 seconds using LUMEN DYNAMICS OmniCure SERIES 1000 and then close the UV radiation. The storage modulus G′ and the loss modulus G″ in a time range can be obtained. And further according to the following formula, the loss factor value (that is, the damping value) tan δ at each time point is calculated from the storage modulus G′ and the loss modulus G″.

i.tan δ=G″/G′

The above measurement process records a series of time-dependent loss factor value forming a rheological curve which may have fluctuation with time increases, owing to moisture curing process lagging behind UV curing. Notably, the loss factor claimed in the present invention refers to the loss factor value at the time point immediately after end of UV radiation.

Preferably, the dually curable adhesive composition of the present invention after UV radiation with a wavelength of 375 nm and intensity of 50 mW/cm² for 60 seconds has a loss factor from 0.7 to less than 1.1, as measured at room temperature in accordance with ASTM D4440-15, the dually curable adhesive composition has excellent cross tensile strength when cured.

### (A) Isocyanate-Terminated Polyurethane Prepolymer

According to the present invention, the dually curable adhesive composition comprises (A) at least one isocyanate-terminated polyurethane prepolymer.

There is no particular limitation on the specific type of isocyanate-terminated polyurethane prepolymer, which can be reaction product of a reaction mixture comprising at least one polyether polyol and at least one polyisocyanate having at least two isocyanate groups in one molecule.

As for the main reactant, useful polyether polyols are derived from oxide monomers (e.g., ethylene oxide, propylene oxide, 1,2-butylene oxide, 1,4-butylene oxide, tetrahydrofuran, and combination thereof) and a polyol initiator (e.g., ethylene glycol, propylene glycol, butanediols, hexanediols, glycerols, trimethylolethane, trimethylolpropane, and pentaerythritol, and combination thereof). Preferably, the said polyether polyol has a molecular weight (Mn) of from 100 g/mol to 8000 g/mol, from 200 g/mol to 4000 g/mol, or even from 200 g/mol to 2000 g/mol.

In preferred embodiments, at least two polyether polyols having molecular weight (Mn) of from 200 g/mol to 2000 g/mol may be used as reactants to prepare the component (A). When two or more polyether polyols are used in the present invention as a mixture to take part in the reaction, each polyether polyol may have a molecular weight (Mn) falling in the above range.

In preferred embodiments, at least one polyhydrofuran is used as polyether polyol to prepare the isocyanate-terminated polyurethane prepolymer used in the present invention. The term “polyhydrofuran” is exchangeable with poly (tetramethylene ether) glycol (PTMEG) and is represented by formula HO—(—(CH₂)₄O—)ₙ—H. Polytetrahydrofuran may be prepared through cationic ring-opening polymerization of tetrahydrofuran. Polytetrahydrofuran is commercially available, for example, as PTMEG 1000, PTMEG 1800, PTMEG 2000 and PTMEG 3000 from Korea PTG Co., Ltd, PolyTHF™ 2000, PolyTHF™ 1000, PolyTHF™ 650 S from BASF.

In particular preferred embodiments, polyether polyols may be present in an amount of from 10 to 85%, preferably from 20 to 75% by weight based on the total weight of the isocyanate-terminated polyurethane prepolymer.

As for the other main reactant, useful polyisocyanates in the present invention include aliphatic polyisocyanates, e.g., hexamethylene diisocyanate (HDI), isophorone diisocyanate (IPDI), hydrogenated diphenylmethane diisocyanate, 1,6-diisocyanato-2,4,4-trimethylhexane, 1,4-cyclohexane diisocyanate (CHDI), 1,4-cyclohexane bis(methylene isocyanate) (BDI), 1,3-bis(isocyanatomethyl)cyclohexane (H6 XDI), dicyclohexylmethane diisocyanate (H12 MDI); aromatic polyisocyanates, e.g., diphenylmethane diisocyanate compounds (MDI) including its isomers (e.g., diphenylmethane 4,4′-diisocyanate, diphenylmethane-2,2′-diisocyanate, diphenylmethane-2,4′-diisocyanate, oligomeric methylene isocyanates having the formula:

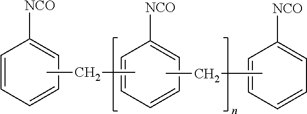

where n is an integer of from 0 to 5, and mixtures thereof), carbodiimide modified MDI, naphthalene diisocyanates including isomers thereof (e.g., 1,5-naphthalene diisocyanate (NDI)), isomers of triphenylmethane triisocyanate (e.g., triphenylmethane-4,4′,4″-triisocyanate), toluene diisocyanate compounds (TDI) including isomers thereof, 1,3-xylene diisocyanate (XDI), tetramethylxylene diisocyanate (TMXDI) (e.g., p-1,1,4,4-tetramethylxylene diisocyanate (p-TMXI) and m-1,1,3,3-tetramethylxylylene diisocyanate (m-TMXDI)), and mixtures thereof.

Preferably, the molar ratio of isocyanate groups to hydroxy groups in the composition used to prepare the polyurethane prepolymer is from 1.5 to 2.8, preferably from 1.8 to 2.3.

In particular preferred embodiments, polyisocyanates may be present in an amount of from 15% to 90%, preferably from 20 to 80% by weight based on the total weight of the isocyanate-terminated polyurethane prepolymer.

In addition to the above two main reactants, an amorphous polyester polyol can be optionally comprised in a very small content as a co-reactant for forming the polyurethane prepolymer of the present invention. It can also be interchangeably expressed as that the amorphous polyester polyol can be optionally comprised in a very small content in the polyurethane prepolymer. For example, the amorphous polyester polyol can be optionally comprised in the polyurethane prepolymer in a content of less than 30 wt %, preferably from 0 to 20 wt % based on the total weight of the isocyanate-terminated polyurethane prepolymer.

The amorphous polyester polyol, if comprised as one reactant, may have a molecular weight (Mn) of from 500 g/mol to 10,000 g/mol, from 600 g/mol to 7000 g/mol, or from 700 g/mol to 6000 g/mol. When two or more amorphous polyester polyols are used in the present invention as a mixture to take part in the reaction, each amorphous polyester polyol may have a molecular weight (Mn) falling in the above range.

The amorphous polyester polyol, if comprised as one reactant, can be liquid or solid. When solid one is used, it is preferable for it to have a softening point of no greater than 80° C., preferably no greater than 60° C., for example, 60° C., 80° C., 100° C.

The amorphous polyester polyol used herein comprises or is a reaction product of one or more polyacids and one or more polyols.

The one or more polyacids can be selected from terephthalic acid (TPA), isophthalic acid (IPA), phthalic acid (PA), methyl-hexahydrophthalic acid, methyl-tetrahydrophthalic acid, hexahydrophthalic acid, tetrahydrophthalic acid, maleic acid, succinic acid, glutaric acid, adipic acid (AA), pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, fumaric acid, 1,3-cyclohexanedicarboxylic acid, 1,4-cyclohexanedicarboxylic acid, anhydrides of the above acids, and combination thereof. Preferably, the one or more polyacids can be selected from terephthalic acid, isophthalic acid, phthalic acid and adipic acid, and anhydrides thereof.

The one or more polyols can be selected from ethylene glycol (EG), propanediols (including 1,2- or 1,3-propanediol), butanediols (including 1,2- or 2,3- or 1,3- or 1,4-butanediol), butenediols (including 1,3- or 2,3 -or 1,4-butenediol), butynediol (including 1,4-butynediol), pentanediols (including 1,2- or 1,3-or 1,4- or 1,5-pentanediol), pentenediols, pentynediols, hexanediols (HD) (including 1,2- or 1,3- or 1,4- or 1,5- or 1,6- or 2,3- or 2,4- or 2,5- or 2,6- or 3,4-hexanediol), octanediols (including 1,2- or 1,3- or 1,4- or 1,5- or 1,6- or 1,7- or 1,8-hexanediol), nonanediols, decanediols, neopentyl glycol (NPG), diethylene glycol (DEG), triethylene glycol, tetraethylene glycol, polyethylene glycols, propylene glycol, dipropylene glycol, tripropylene glycol, cyclohexanedimethanol, cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 2-methyl-1,8-octanediol, trimethylolpropane, pentaerythritol, sorbitol, glucose, and combination thereof. Preferably, the one or more polyols can be selected from hexanediols (including 1,2- or 1,3- or 1,4- or 1,5-or 1,6- or 2,3- or 2,4-or 2,5-or 2,6-or 3,4- hexanediol), ethylene glycol, neopentyl glycol, diethylene glycol.

Furthermore, a polycarbonate polyol can be optionally comprised in a very small content as a co-reactant for forming the polyurethane prepolymer of the present invention. For example, the polycarbonate polyol can be optionally comprised in the polyurethane prepolymer in a content of less than 30 wt %, preferably from 0 to 20 wt % based on the total weight of the isocyanate-terminated polyurethane prepolymer.

The term “polycarbonate polyol” is understood as having repeating unit —O—C(═O)—O— and is terminated by one or more, preferably two hydroxyl groups. The polycarbonate polyol can be solid or liquid at room temperature.

Polycarbonate polyols can be prepared, for example, by the reaction from aliphatic polyols, like propylene glycol, 1,4-butanediol, 1,5-pentadiol, 1,6-hexenediol, diethylene glycol, triethylene glycol or mixtures thereof, with diarylcarbonates or dialkylcarbonates, such as dimethylcarbonate.

Polycarbonate polyols are commercially available. For example, they are sold as a series of products under the tradename Duranol™ by Asahi Kasei Corporation. Specific examples of polycarbonate diols include Duranol™ T5652, Duranol™ T5651, Duranol™ T5650J, Duranol™ T5650E, Duranol™ T4672, Duranol™ T4671, Duranol™ T4692, Duranol™ T4691, Duranol™ T6001, Duranol™ T6002, Duranol™ G3452 and Duranol™ G3450J.

In a particularly preferred embodiment, the reaction mixture to prepare component (A), based on the total weight of the reaction mixture, comprising:
from 10% to 85%, preferably from 20% to 80% by weight of polyether polyols,
from 0 to 30%, preferably from 0 to 20% by weight of amorphous polyester polyol,
from 0 to 30%, preferably from 0 to 20% by weight of polycarbonate diols, and
from 15% to 90%, preferably from 20% to 80% by weight of polyisocyanate having at least two isocyanate groups in one molecule.

With particular preference, the component (A) may be present in an amount of from 5% to 90% by weight, and preferably from 10% to 80% by weight, based on the total weight of the adhesive composition.

### (B) Free Radically Polymerizable Compound

According to the present invention, the dually curable adhesive composition comprises (B) at least one free radically polymerizable compound.

There is no particular limitation on the specific type of the free radically polymerizable compound. The free-radical polymerizable component (B), that is, a component which undergoes polymerization initiated by free radicals. Useful free-radical polymerizable components are (meth) acrylates or (meth)acrylamide monomers, oligomers, and/or polymers; they are monofunctional or polyfunctional materials, i.e., have 1, 2, 3, 4, 5, 6, 7, 8, 9, 10 . . . 20 . . . 30 . . . 40 . . . 50 . . . 100, or more functional groups that can polymerize by free radical initiation, may contain aliphatic, aromatic, cycloaliphatic, arylaliphatic, heterocyclic moiety(ies), or any combination thereof. The term “monofunctional” means including one acrylate functional group having photo reactivity, and the term “polyfunctional” means including two or more acrylate functional groups having photo reactivity.

The free radically polymerizable compound can be selected from (meth)acrylate monomer, (meth)acrylamide monomer, (meth)acrylate oligomer, (meth)acrylamide oligomer, (meth)acrylate polymer, (meth)acrylamide polymer, and combination thereof, preferably monofunctional (meth)acrylate monomer, monofunctional (meth)acrylamide monomer, monofunctional urethane (meth)acrylate oligomer, bifunctional urethane (meth)acrylate oligomer, and combination thereof.

In some embodiments, the component (B) can have at least one (meth)acrylate monomer or (meth)acrylamide monomer, in which may contain aliphatic, aromatic, cycloaliphatic, arylaliphatic, heterocyclic moiety(ies), or any combination thereof.

In the present invention, the term “(meth)acrylate” refer to both or either of acrylate and methacrylate, the term “(meth)acryl” represents both or either of acryl and methacryl, the term “(meth)acryloyl” represents both or either of acryloyl and methacryloyl, and the term “(meth)acryamide” represents both or either of acrylamide and methacrylamide.

Preferably, monofunctional (meth)acrylate monomer and/or monofunctional (meth)acrylamide monomer may be used in the present invention. Compared with (meth)acrylate monomer or (meth)acrylamide monomer having a functionality of two or more, monofunctional (meth)acrylate monomer or (meth)acrylamide monomer may have a lower crosslinking density, which makes the adhesive composition after radiation easy to be compressed. In an embodiment according to the present invention, the (meth)acrylate monomer or (meth)acrylamide monomer has a weight average molecular weight (Mw) of 2,000 or less.

More preferably, cycloaliphatic (meth)acrylate monomer and/or cycloaliphatic (meth)acrylamide monomer may be used in the present invention. The adhesive composition comprising cycloaliphatic (meth)acrylate monomer and/or cycloaliphatic (meth)acrylamide monomer is easier to be compressed after UV radiation and has higher lap shear strength when cured.

There is no specific limitation to the type of (meth)acrylate monomer or (meth)acrylamide monomer, and those commonly used in adhesives can be used. Preferably, the (meth)acrylate monomer or (meth)acrylamide monomer is selected from the group consisting of butyl (meth)acrylate, isodecyl acrylate, phenoxyethyl acrylate, 3,3,5-trimethylcyclohexyl acrylate, 2-[(butylamino)carbonyl]oxy]ethyl acrylate, and mixtures thereof.

In some embodiments, the component (B) can have at least one urethane (meth)acrylate oligomer, in which may contain aliphatic, aromatic, cycloaliphatic, arylaliphatic, heterocyclic moiety(ies), or any combination thereof.

The term “urethane acrylate oligomer” as used herein refers to acrylate oligomer containing at least one urethane linkage. The urethane group has the general structure —O—(CO)—NR—, where (CO) defines a carbonyl group C═O, and R is hydrogen or an alkyl group.

According to an exemplary embodiment of the present invention, the dually curable adhesive composition includes a polycarbonate-based urethane (meth)acrylate oligomer. The polycarbonate-based (meth)urethane acrylate oligomer is an oligomer having both a polycarbonate chemical structure and a urethane chemical structure, and may be prepared, for example, by reacting a polycarbonate polyol with an isocyanate compound having a (meth)acrylate group. Through the oligomer having both the polycarbonate structure and the urethane structure as described above, the dually curable adhesive composition may exhibit excellent adhesive strength as compared to oligomers which do not have both a polycarbonate chemical structure and a urethane chemical structure.

Preferably, the urethane (meth)acrylate oligomer may be monofunctional and/or bifunctional. In an embodiment according to the present invention, the urethane acrylate oligomer has a weight average molecular weight (Mw) of from 800 to 100000 g/mol.

There is no specific limitation to the type of urethane (meth)acrylate oligomer, and those commonly used in adhesives can be used. Preferably, examples of urethane (meth)acrylate oligomer include, but are not limited to polybutadiene urethane acrylate oligomer, polyester-based urethane acrylate oligomer, polyether-based urethane acrylate oligomer, polycarbonate-based urethane acrylate oligomer, polycaprolactones urethane acrylate oligomer, and the like.

The above-mentioned free radically polymerizable compounds can be used singly or in combination of two or more thereof.

Examples of a commercially available product of the component (B) may include urethane (meth) acrylate oligomers available from polycarbonate-based urethane diacrylate oligomer under tradename of CN8888NS, polyester/polyether urethane diacrylate oligomer under tradename of CN981, polyester-based urethane diacrylate oligomer under tradenames of CN991, CN964, CN965, CN962 and CN966J75, all manufactured by Sartomer; (meth) acrylate monomers or (meth) acrylamide monomers available from SR 339NS, SR395, SR420, SR268 and SR259 manufactured by Sartomer and Photomer 4184 manufactured by IGM.

With particular preference, the component (B) may be present in an amount of from 5% to 90% by weight, and preferably from 10% to 80% by weight, based on the total weight of the adhesive composition.

### (C) Photoinitiator

According to the present invention, the dually curable adhesive composition comprises (C) at least one photoinitiator. The photoinitiator may initiate and accelerate the crosslinking of the component (B) upon exposure to UV light. By employing the photoinitiator, the composition according to the present invention may cure rapidly in less than 1 minute, preferably in tens of seconds, and more preferably in 1 to 10 seconds.

There is no special limitation for the photo radical polymerization initiator used in the present invention, as long as it is capable of promoting free radical polymerization, crosslinking, or both. The photo radical polymerization initiator and the amount thereof is preferably selected to achieve a uniform reaction conversion, as a function of the thickness of the composition being cured, as well as a sufficiently high degree of total conversion so as to achieve the desired initial handling strength.

Useful photo radical polymerization initiators include, but not limited to, “alpha cleavage type” photo radical polymerization initiators including, e.g., benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones; hydrogen abstracting photo radical polymerization initiators, which include a photo radical polymerization initiator and a coinitiator, based on benzophenones, thioxanthones, benzyls, camphorquinones, and ketocoumarins; and combination thereof.

Preferred photo radical polymerization initiators include acylphosphine oxides including, e.g., bis(2,4,6-trimethylbenzoyl)-phenylphosphine oxide, bis(2,6-dimethoxybenzoyl)-(2,4,4-trimethylpentyl)phosphine oxide, and 2,4,4-trimethylbenzoyl diphenylphosphine oxide.

These photo radical polymerization initiators may be used alone or two or more of them may be used in combination.

Useful commercially available photo radical polymerization initiators are available under the following trade designations Omnirad 369 morpholino phenyl amino ketone, Omnirad 819 bis(2,4,6-trimethylbenzoyl)-phenylphosphine oxide and its preferred form CGI819XF, Omnirad CGI 403 bis(2,6-dimethoxybenzoyl)-(2,4,4-trimethylpentyl) phosphine oxide, Omnirad 651 benzyl dimethyl ketal, Omnirad 184 benzoyl cyclohexanol, Omnirad 1173 hydroxy alkyl phenyl ketones, Omnirad 4265 50:50 blend of 2-hydroxy-2-methyl-1-phenylpropan-1-one and 2,4,6-trimethylbenzoyldiphenylphosphine oxide, and CGI1700 25:75 blend of bis(2,6-dimethoxybenzoyl)-2,4,4-trimethylpentylphosphine and 2-hydroxy-2-methyl-1-phenylpropan-1-one, Speedcure TPO-L of ethyl phenyl(2,4,6-trimethylbenzoyl)phosphinate all of which are available from IGM.

In general, when photo radical polymerization initiator is present in the compositions, these compositions will be cured at room temperature within a length of time of less than 120 seconds, preferably less than 60 seconds at wavelength in a range from 200 nm to 410 nm, followed by a heating curing process described herein. As will be understood, the time and wavelength curing profile for each curable adhesive composition will vary, and different compositions can be designed to provide the curing profile that will be suited to the particular industrial manufacturing process.

With particular preference, the component (C) if present, can be in an amount of 0.01% to 10%, preferably 0.3% to 5%, by weight of the total composition.

### (D) Moisture Curing Catalyst

According to the present invention, the dually curable adhesive composition comprises (D) at least one moisture curing catalyst.

There is no special limitation for moisture curing catalysts used in the present invention, as long as it is capable of accelerating the moisture curing process. Useful catalysts herein include compound having ether and morpholine functional groups, include but not limited to, 2,2′-dimorpholinoethylether, di(2,6-dimethyl morpholinoethyl) ether, and 4,4′-(oxydi-2,1-ethanediyl)bis-morpholine; metal catalysts including, e.g., catalysts based on tin (e.g. dibutyltin dilaurate and dibutyltin acetate), bismuth, zinc, potassium and combination thereof.

Useful commercially available moisture curing catalysts are available under the following trade designations, Jeffcat DMDEE, Catalyst CC, T9, BICAT 8 and mixture thereof.

With particular preference, the dually curable adhesive composition can be in an amount of from 0.01% by weight to 5% by weight or even from 0.05% by weight to 3% by weight catalyst to facilitate moisture cure.

### Additives

The dually curable adhesive composition may optionally include a variety of additives including, e.g., thermoplastic polymer, tackifying agent, plasticizer, wax, stabilizer, antioxidant, filler, pigment, fluorescing agent, odor mask, adhesion promoter (i.e., silane-based adhesion promoters), surfactant, defoamer, and combination thereof.

Useful thermoplastic polymers include, e.g., ethylene vinyl acetate, ethylene vinyl acetate and vinyl alcohol copolymer, ethylene vinyl butyrate, ethylene acrylic acid, ethylene methacrylic acid, ethylene acrylamide copolymer, ethylene methacrylamide, acrylate copolymers (e.g., methyl acrylate, ethyl acrylate, methyl methacrylate, 2-ethylhexyl acrylate, 2-ethylhexyl methacrylate, methoxyethyl methacrylate, methoxyethyl acrylate, ethylene ethyl acrylate, ethylene n-butyl acrylate, and ethylene hydroxyethyl acrylate), ethylene n-butyl acrylate carbon-monoxide terpolymer, polyolefins (e.g., polypropylene and polyethylene), thermoplastic polyurethane, butylene/poly (alkylene ether) phthalate, thermoplastic polyester, and combination thereof. The dually curable adhesive composition optionally includes from 0% by weight to no greater than 4% by weight or even from 0.1% by weight to no greater than 4% by weight thermoplastic polymer.

Useful tackifying agents include, e.g., aromatic, aliphatic, and cycloaliphatic hydrocarbon resins, mixed aromatic and aliphatic modified resins, aromatic modified hydrocarbon resins, and hydrogenated versions thereof; terpenes, modified terpenes, and hydrogenated versions thereof; rosin esters (e.g., glycerol rosin ester, pentaerythritol rosin ester, and hydrogenated versions thereof); and combination thereof. Useful aromatic resins include, e.g., aromatic modified hydrocarbon resins, alpha-methyl styrene resin, styrene, polystyrene, coumorone, indene, and vinyl toluene, and styrenated terpene resin, polyphenols, polyterpenes, and combination thereof. Useful aliphatic and cycloaliphatic petroleum hydrocarbon resins include, e.g., branched and unbranched C5 to C9 resins and the hydrogenated derivatives thereof. Useful polyterpene resins include copolymers and terpolymers of natural terpenes (e.g. styrene-terpene, alpha-methyl styrene-terpene, and vinyl toluene-terpene).

Examples of useful antioxidants include hindered phenolic antioxidants, phosphite antioxidants, thioether antioxidants. Commercially available examples include Omnirad 565, 1010, 1076, and Evernox 10 available from BASF. The dually curable adhesive composition optionally includes no greater than 2% by weight of antioxidant.

Examples of useful stabilizer include 4-methylbenzenesulfonyl isocyanate available under PTSI from Borchers.

The fillers can be in a variety of forms including, e.g., particles (spherical particles, beads, and elongated particles), fibers, and combination thereof. Examples of useful fillers include talcs, clays, fumed silicas and surface-treated versions thereof, carbon blacks and micas, microparticles including, e.g., microspheres selected from glass microspheres, polymer microspheres, and combination thereof. Commercially available examples include RY300 available from Evonik. The dually curable adhesive composition optionally includes no greater than 5% by weight of filler.

Examples of useful pigments include inorganic, organic, reactive, and nonreactive pigments, and combination thereof.

Suitable silane-based adhesion promoters include, e.g., epoxy glycidoxy propyl trimethoxy silane, octyltriethoxysilane, methyltrimethoxysilane, beta-(3,4-epoxy cyclohexyl)ethyl trimethoxy silane, methacryloxypropyl trimethoxy silane, alkyloxyiminosilyls, vinyl trimethoxy silane, vinyl triethoxy silane, vinyl methyl dimethoxy silane, amino propyl trimethoxy silane, amino propyl triethoxy silane, N-phenyl amino propyl trimethoxy silane, bis-(trimethoxy silyl propyl) amine, N-beta-(aminoethyl)-amino propyl trimethoxy silane, N-beta-(aminoethyl)-amino propyl trimethoxy silane, N-beta-(aminoethyl-amino propyl-methyl dimethoxy silane, ureido propyl trimethoxy silane, tris[3-(trimethoxysilyl) propyl] isocyanurate, 4-amino-3,3-dimethylbutyldimethoxymethylsilane, and ethoxy and methoxy/ethoxy versions thereof, mercaptopropyl trimethoxysilane, and mixture thereof. Commercially available examples include Silquest A-189 available from Momentive. The dually curable adhesive composition optionally includes no greater than 2% by weight of silane-based adhesion promoters.

The additives in total may constitute no more than 15 wt %, preferably no more than 10 wt. % of the adhesive composition of the present invention.

### Adhesive Composition

In particular preferred embodiments, the dually curable adhesive composition, based on the total weight of the adhesive composition, comprises:
from 5% to 90% by weight, preferably from 10% to 80% by weight of at least one at least one isocyanate- terminated polyurethane prepolymer,
from 5% to 90% by weight, preferably from 10% to 80% by weight of at least one radical polymerizable compound,
from 0.01% to 10% by weight, preferably from 0.3% to 5% by weight of at least one photoinitiator,
from 0.01% to 5% by weight, preferably from 0.05% to 3% by weight of at least one moisture curing catalyst, and
from 0.01% to 15% by weight, preferably from 0.01% to 10% by weight of at least one additive.

### Preparation Method

The dually curable adhesive composition according to the present invention can be prepared by mixing all components according to the present invention until homogeneous mixture is obtained.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the dually curable adhesive composition is not particularly limited, as long as a composition in which the above-described components are uniformly mixed.

### Laminate and Electronic Device

According to a second aspect of the invention, provided herein is a laminate, comprising a first substrate, a second substrate, and an adhesive layer sandwiched therebetween, wherein the first and second substrates are independently of each other selected from a glass, a resin and a metal, preferably at least one of the two substrates is non-UV transparent, and the adhesive layer being formed by curing the adhesive composition of the present invention.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combination thereof.

The substrates of the article can be in a variety of forms including, e.g., fibers, threads, yarns, wovens, nonwovens, films (e.g., polymer film, metallized polymer film, continuous films, discontinuous films, and combination thereof), foils (e.g., metal foil), sheets (e.g., metal sheet, polymer sheet, continuous sheets, discontinuous sheets, and combination thereof), and combination thereof.

In preferred embodiments, at least one of the substrates can be selected from non-UV transparent materials, such as metal firing pastes, aluminum, tin, molybdenum, silver, conductive metal oxides such as indium tin oxide (ITO), fluorine doped tin oxide, aluminum doped zinc oxide etc, glasses such as inked glass, bare glass, resins such as polycarbonate, polybutylece terephthalate and polyamide. Further suitable metals include copper, gold, palladium, platinum, aluminum, indium, silver coated copper, silver coated aluminum, tin, and tin coated copper. Preferably both substrates are selected from one of the aforementioned materials.

The dually curable adhesive composition of the present invention can cure by UV at wavelength of from 200 to 410 nm, preferably from 320 to 400 nm for 3 seconds to 60 seconds and then further cure at room temperature within the range of from 15° C. to 35° C. and 50% relative humidity for from 1 to 7 days.

As will be understood, the time and temperature curing profile for each dually curable adhesive composition will vary, and different compositions can be designed to provide the curing profile that will be suited to the particularly industrial manufacturing process.

According to a third aspect of the invention, provided herein is an electronic device, comprising the laminate of the present invention or produced using the adhesive composition according to the present invention.

The dually curable adhesive composition of the present invention can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combination thereof. The dually curable adhesive composition can be applied as a continuous or discontinuous coating, in a single or multiple layers and combination thereof.

### Use

According to a fourth aspect of the invention, provided herein is the use of the adhesive composition according to the present invention or the laminate according to the present invention in manufacturing electronic devices.

The said suitable electronic devices includes, but not limited to, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials

PolyTHF™ 2000 is a polytetrahydrofuran polyol having a molecular weight (Mn) of 2000 g/mol, available from BASF.

PolyTHF™ 1000 is a polytetrahydrofuran polyol having a molecular weight (Mn) of 1000 g/mol, available from BASF.

PolyTHFT 650 S is a polytetrahydrofuran polyol having a molecular weight (Mn) of 650 g/mol, available from BASF.

Voranol 2110 is polyether polyol having a molecular weight (Mn) of 1000 g/mol, available from Dow.

Desmodur™ 44C is a monomeric diphenylmethane-4,4′-diisocyanate, available from Covestro Polymers (China) Co., Ltd.

Evernox 10 is pentaerythritol tetrakis[3-(3,5-di-tert-butyl-4-hydroxyphenyl) propionate as antioxidant, available from Everspring Chemical.

PTSI is 4-methylbenzenesulfonyl isocyanate as stabilizer, available from Borchers.

CN8888NS is polycarbonate-based urethane diacrylate oligomer, available from Sartomer.

Photomer 4184 is monofunctional 2-[(butylamino)carbonyl]oxy]ethyl acrylate monomer, available from IGM.

SR 339 NS is monofunctional phenoxyethyl acrylate monomer, available from Sartomer.

SR 395 is monofunctional isodecyl acrylate monomer, available from Sartomer.

SR 420 is monofunctional 3,3,5-trimethylcyclohexyl acrylate monomer, available from Sartomer.

SR 268 is tetraethylene glycol diacrylate monomer, available from Sartomer.

SR 259 is ethylene diacrylate monomer, available from Sartomer.

Speedcure TPO-L is ethyl phenyl(2,4,6-trimethylbenzoyl)phosphinate, available from IGM.

Jeffcat DMDEE is 2,2-dimorpholinodiethyl ether, available from Huntsman.

Silquest A 189 is silane-based adhesion promoter, available from Momentive.

RY 300 is fumed silica Filler, available from Evonik.

### Preparation Method

Preparation for component (A) isocyanate-terminated polyurethane prepolymers:

78.68 g PolyTHF™ 2000 and 0.47 g Evernox 10 were added to a reactor. Under vacuum of 30 mbar, stirring was carried out at 150° C. for 2 hours for mixing to remove water. Thereafter, cooling down to 110° C., and then adding 20.85 g Desmodur™ 44C into the mixture, stirring at 110° C. for 10 minutes, and then keeping for 1 hour at 120° C. under vacuum of 30 mbar, the isocyanate-terminated polyurethane PU-09 was obtained.

9.33 g Voranol 2110, 9.33 g PolyTHF™ 1000, 55.95 g PolyTHF™ 2000, and 0.47 g Evernox 10 were added to a reactor. Under vacuum of 30 mbar, stirring was carried out at 150° C. for 2 hours for mixing to remove water. Thereafter, cooling down to 110° C., and then adding 24.45 g Desmodur 44C, stirred at 110° C. for 10 minutes, and then keeping for 1 hour at 120° C. under vacuum of 30 mbar. 0.47 g PTSI was added and stirred for 15 minutes at 120° C., then the isocyanate-terminated polyurethane PU-43 was obtained.

9.09 g PolyTHF™ 650 S, 9.09 g PolyTHF™ 1000, 54.47 g PolyTHF™ 2000, and 0.47 g Evernox 10 were added to a reactor. Under vacuum of 30 mbar, stirring was carried out at 150° C. for 2 hours for mixing to remove water. Thereafter, cooling down to 110° C., and then adding 26.41 g Desmodur 44C, stirred at 110° C. for 10 minutes, and then keeping for 1 hour at 120° C. under vacuum of 30 mbar. 0.47 g PTSI was added and stirred for 15 minutes at 120° C., then isocyanate-terminated polyurethane PU-44was obtained.

Preparation for the dually curable adhesive composition of the Examples and Comparative Examples:

### Comparative Example 1 (CEx.1)

5.0 g Photomer 4184, 25.0 g SR 420, 15.0 g SR 259, 0.5 g Silquest A 189, 2.0 g Speedcure TPO-L and 49.5 g PU-09 were mixing in planet mixer under nitrogen, and then added 2.5 g RY 300 into the mixer for 30 minutes. Mixing the mixture at 70° C., and then added 0.5 g Jeffcat DMDEE into the mixer and the air was extracted for 30 minutes to obtain the sample.

### Comparative Example 2 (CEx.2)

5.0 g Photomer 4184, 10.0 g SR 420, 15.0 g SR 268, 0.5 g Silquest A 189, 2.0 g Speedcure TPO-L, 20.0 g CN8888NS and 45.0 g PU-09 were mixing in planet mixer under nitrogen, and then added 2.0 g RY 300 into the mixer for 30 minutes. Mixing the mixture at 70° C., and then added 0.5 g Jeffcat DMDEE into the mixer and the air was extracted for 30 minutes to obtain the sample.

### Example 1

10.0 g SR 420, 20.0 g SR 339NS, 0.5 g Silquest A 189, 2.0 g Speedcure TPO-L, 15.0 g CN8888NS and 51.0 g PU-43 were mixing in planet mixer under nitrogen, and then added 1.0 g RY 300 into the mixer for 30 minutes. Mixing the mixture at 70° C., and then added 0.5 g Jeffcat DMDEE into the mixer and the air was extracted for 30 minutes to obtain the sample.

### Example 2

10.0 g SR 420, 20.0 g SR 339NS, 0.5 g Silquest A 189, 2.0 g Speedcure TPO-L, 15.0 g CN8888NS and 51.0 g PU-44 were mixing in planet mixer under nitrogen, and then added 1.0 g RY 300 into the mixer for 30 minutes. Mixing the mixture at 70° C., and then added 0.5 g Jeffcat DMDEE into the mixer and the air was extracted for 30 minutes to obtain the sample.

### Example 3

15.0 g SR 420, 25.0 g SR 395, 0. 5g Silquest A 189, 2.0 g Speedcure TPO-L, and 55.0 g PU-09 were mixing in planet mixer under nitrogen, and then added 3 g RY 300 into the mixer for 30 minutes. Mixing the mixture at 70° C., and then added 0.5 g Jeffcat DMDEE into the mixer and the air was extracted for 30 minutes to obtain the sample.

### Example 4

15.0 g SR 420, 25.0 g Photomer 4184, 0.5 g Silquest A 189, 2.0 g Speedcure TPO-L, and 55.0 g PU-09 were mixing in planet mixer under nitrogen, and then added 2.5 g RY 300 into the mixer for 30 minutes. Mixing the mixture at 70° C., and then added 0.5 g Jeffcat DMDEE into the mixer and the air was extracted for 30 minutes to obtain the sample.

### Example 5

25.0 g SR 420, 10.0 g Photomer 4184, 0.5 g Silquest A 189, 2.0 g Speedcure TPO-L, and 60.0 g PU-09 were mixing in planet mixer under nitrogen, and then added 3.0 g RY 300 into the mixer for 30 minutes. Mixing the mixture at 70° C., and then added 0.5 g Jeffcat DMDEE into the mixer and the air was extracted for 30 minutes to obtain the sample.

### Example 6

25.0 g SR 420, 15.0 g Photomer 4184, 0.5 g Silquest A 189, 2.0 g Speedcure TPO-L, and 55.0 g PU-09 were mixing in planet mixer under nitrogen, and then added 3.0 g RY 300 into the mixer for 30 minutes. Mixing the mixture at 70° C., and then added 0.5 g Jeffcat DMDEE into the mixer and the air was extracted for 30 minutes to obtain the sample.

### Example 7

25.0 g SR 339NS, 15.0 g SR 395, 0.5 g Silquest A 189, 2.0 g Speedcure TPO-L, and 55.0 g PU-09were mixing in planet mixer under nitrogen, and then added 3 g RY 300 into the mixer for 30 minutes. Mixing the mixture at 70° C., and then added 0.5 g Jeffcat DMDEE into the mixer and the air was extracted for 30 minutes to obtain the sample.

### Test Methods

### Loss Factor Value Tan δ

The loss factor value of each sample was measured by using Modular Compact Rheometer MCR 302e from Anton Paar in accordance with dynamic oscillation test of ASTM D4440-15, in which a plate clamp having a diameter of 25 mm and a thickness of 1 mm was used to hold the adhesive composition sample, and when the a frequency of 10 rads at room temperature and the strain was less than or equal to 0.01%, rheological measurement under oscillation mode was performed 60 seconds for stabilization, and then radiation with wavelength of 375 nm at the intensity of 50 mW/cm2 was performed for another 60 seconds using LUMEN DYNAMICS OmniCure SERIES 1000 to obtain the storage modulus G′ and the loss modulus G″ and further according to the following formula, the loss factor value tan δ was calculated from the storage modulus G′ and the loss modulus G″:

i.tan δ=G″/G′

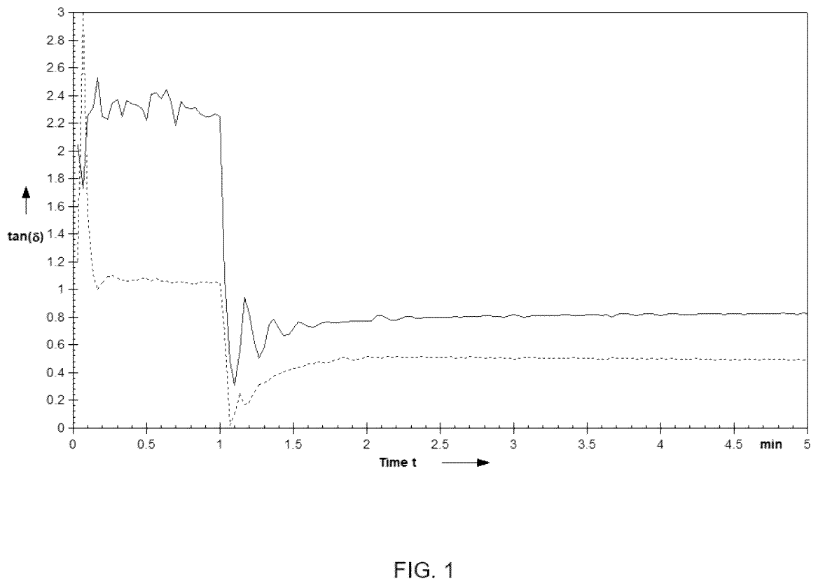

The loss factor value tan o can also be calculated automatically from MCR 302e. As can be seen from FIG. 1, the rheological curves of Example 1 (solid line) and Comparative Example 1 (dotted line) within a time range of from 0 to 5 minutes were measured by MCR 302e, indicating the loss factor value@120 seconds is 0.76 and 0.51 respectively (immediately after end of UV radiation). Each sample was tested, and the loss factor value @120 seconds was recorded in Table 1.

### Compressibility After Exposure to UV Irradiation

The compressibility of each sample after exposure to UV irradiation was evaluated according to the following steps. Firstly, each sample was dispensed onto an inked glass having a dimension of (101.6 mm*25.4 mm*2 mm), and then irradiating the samples with a LED lamp at wavelength of 375 nm at intensity of 150 mW/cm2 for 20 seconds; and the adhesive bead width was observed by optical microscope and measured accordingly, recorded as initial adhesive bead width after exposure to UV irradiation. Afterwards, a polycarbonate substrate was laminated onto the adhesive sample under a compressive load of 2 kilogram for 15 seconds, and the adhesive bead width was observed by optical microscope and measured accordingly, recorded as adhesive bead width after compressing. The compressibility of the adhesive composition samples after exposure to UV irradiation was calculated according to the following formula:

$$Compressibility ( \% ) = \frac{\begin{matrix}The adhesive bead width after compressing - The initial \\ adhesive bead width after exposure to UV irradition\end{matrix}}{The initial adhesive bead width after exposure to UV irradition} \times 100 \%$$

A sample with a higher compressibility indicates that it is easy to compress, demonstrating its applicability to its desired use. More specifically, a sample with a compressibility of 20% or more was evaluated as “O”, a sample with a compressibility of larger than 0% and less than 20% was evaluated as “Δ”, and a sample with a compressibility of 0% or less was evaluated as “X”.

### Cross Tensile Strength

Sample Preparation:
I. Firstly, polycarbonate substrate of size 101.6 mm*25.4 mm*2 mm and ink glass substrate of size 101.6 mm*25.4 mm*3 mm were prepared. The substrates were cleaned with isopropanol and idled at ambient conditions for several minutes to make sure the surface was completely dry. The first substrate and the second substrate were placed crosswise and the overlapping area was to be formed an adhesive layer sandwiched therebetween.
II. Then, two spacers with diameter of 0.1 mm were set up to control the thickness of the adhesive layer. Before dispersing the adhesive composition, the said spacers were placed at the edge of the first substrate with a distance of 5 mm from the edge of the overlapping area.
III. After that, the adhesive composition was dispensed by Loctite 400D dispense machine at room temperature. A needle of 19#size was used for dispensing the adhesive composition to the surface of ink glass. During the dispensing process, two bond lines were formed by adhesive beads dispensed through the needle. The two bond lines were applied parallelly and each one had a distance of 5.0 mm to the edge of the overlapping area of the two substrates. Furthermore, the distance between each adhesive bead were controlled at 15.4 mm.
IV. After dispensing, the adhesive beads were cured by 375 nm LED lamp with the intensity 150 mw/cm² for 20 seconds irradiation. A polycarbonate substrate was pressed on the bead lines to form a sandwich construction of the overlapping area while leaving two free ends of each substrate. Then the laminate was prepared.
V. A 2-kilogram weight was applied to the sandwich construction of the overlapping area for 15 seconds. Then the weight was removed, and the resulting samples were placed at 23° C. and 50% relative humidity for 24 hours to cure the adhesive composition.

Sample Testing:

To determine the tensile strength at break of an adhesive layer, the cross tensile strength of the samples was measured by INSTRON tensile tester with a test speed of 10 mm/min. The load at failure was recorded accordingly. The adhesive composition was considered to be acceptable where the cross tensile strength was greater than or equal to 75N, preferably greater than 100N.

TABLE 1

| | CEx. | CEx. | Ex. | Ex. | Ex. | Ex. | Ex. | Ex. | Ex. |
|---|---|---|---|---|---|---|---|---|---|
| | 1 | 2 | 1 | 2 | 3 | 4 | 5 | 6 | 7 |
| Loss factor | 0.51 | 0.45 | 0.77 | 0.67 | 0.99 | 1.11 | 1.33 | 1.4 | 0.95 |
| value tan δ | | | | | | | | | |
| @120 seconds | | | | | | | | | |
| Compressibility | X | X | ◯ | ◯ | ◯ | Δ | Δ | Δ | Δ |
| scale | | | | | | | | | |
| Cross tensile | 67.51 | 55.05 | 197.00 | 189.00 | 105.62 | 104.05 | 213.80 | 256.90 | 99.25 |
| strength (N) | | | | | | | | | |

As can be seen from Table 1, the dually curable adhesive composition having loss factor value @120 seconds more than 0.6 exhibiting remarkable compressibility and excellent cross tensile strength when cured, compared with comparative examples having loss factor value beyond the claimed range.

Although some preferred embodiments have been described, many modifications and variations may be made thereto in light of the above teachings. It is therefore to be understood that the invention may be practiced otherwise than as specifically described without departing from the scope of the appended claims.

1. A dually curable adhesive composition comprising:
(A) at least one isocyanate-terminated polyurethane prepolymer,
(B) at least one radical polymerizable compound,
(C) at least one photoinitiator selected from benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones,morpholino phenyl amino ketones, benzophenones, thioxanthones, benzyls, camphorquinones or ketocoumarins, and
(D) at least one moisture curing catalyst,
wherein the composition after UV radiation with a wavelength of 375 nm and intensity of 50 mW/cm² for 60 seconds, has a loss factor value larger than 0.6, as measured at room temperature in accordance with ASTM D4440-15.

2. The dually curable adhesive composition according to claim 1, wherein the component (A) is the reaction product of a reaction mixture comprising at least one polyether polyol and at least one polyisocyanate having at least two isocyanate groups in one molecule.

3. The dually curable adhesive composition according to claim 2, wherein the polyether polyol is polyhydrofuran.

4. The dually curable adhesive composition according to claim 2, wherein the reaction mixture further comprises at least one amorphous polyester polyol and/or polycarbonate polyol.

5. The dually curable adhesive composition according to claim 2, wherein the reaction mixture comprises:
from 20 to 80% by weight of polyether polyol,
from 0 to 20% by weight of amorphous polyester polyol,
from 0 to 20% by weight of polycarbonate polyol, and
from 20 to 80% by weight of polyisocyanate having at least two isocyanate groups in one molecule, based on the total weight of the reaction mixture.

6. The dually curable adhesive composition according to claim 1, wherein the component (B) is selected from the group consisting of monofunctional (meth)acrylate monomer, monofunctional (meth)acrylamide monomer, monofunctional urethane (meth)acrylate oligomer, bifunctional urethane (meth)acrylate oligomer, and combination thereof.

7. (canceled)

8. The dually curable adhesive composition according to claim 1, wherein the component (D) is selected from the group consisting of 2,2′-dimorpholinoethylether, di(2,6-dimethyl morpholinoethyl)ether, 4,4′-(oxydi-2,1-ethanediyl)bis-morpholine, dibutyltin dilaurate and dibutyltin acetate, and combination thereof.

9. The dually curable adhesive composition according to claim 1, wherein the composition further comprises at least one additive selected from thermoplastic polymer, tackifying agent, plasticizer, wax, stabilizer, antioxidant, filler, pigment, fluorescing agent, odor mask, adhesion promoter, surfactant, defoamer, and combination thereof.

10. The dually curable adhesive composition according to claim 1, wherein the component (A) is present in an amount of 10% to 80% by weight of the total weight of the composition.

11. The dually curable adhesive composition according to claim 1, wherein the component (B) is present in an amount of from 10% to 80% by weight of the total weight of the composition.

12. The dually curable adhesive composition according to claim 1, wherein the component (C) is present in an amount of 0.3% to 5% by weight of the total weight of the composition.

13. The dually curable adhesive composition according to claim 1, 0.05% to 3% by weight of the total weight of the composition.

14. A laminate, comprising a first substrate, a second substrate, and an adhesive layer sandwiched therebetween, wherein the first and second substrates are independently of each other selected from a glass, a resin a metal,
wherein at least one of the two substrates is non-UV transparent, and
wherein the adhesive layer is the cured adhesive composition according to claim 1.

15. An electronic device, comprising the laminate of claim 14 .

16. (canceled)
